(19) United States
(12) Patent Application Publication
(10) Pub. No.: US 2017/0235210 A1
(43) Pub. Date: Aug. 17, 2017

(54) LIGHT EMITTING DEVICE AND ELECTRONIC DEVICE INCLUDING THE SAME

(71) Applicant: Samsung Electronics Co., Ltd., Suwon-si (KR)

(72) Inventor: Ji Eun Jun, Yongin-si (KR)

(21) Appl. No.: 15/270,060

(22) Filed: Sep. 20, 2016

(30) Foreign Application Priority Data
Feb. 11, 2016 (KR) 10-2016-0015766

(51) Int. Cl. G03B 15/05; F21V 9/08; F21S 9/02; G09F 13/00; F21V 14/08; F21V 3/00; G09F 13/06; F21V 8/00; H05B 33/08

(52) U.S. Cl. CPC G03B 15/05; G02B 6/0031; G02B 6/0003; F21V 9/08; F21S 9/02; H05B 33/0845; H05B 33/0896; F21V 14/08; F21V 3/00; G09F 13/06; G09F 13/005; F21Y 2115/10

(57) ABSTRACT

A light emitting device includes a cover panel including a plurality of light emitting regions and a light source disposed on a surface of the cover panel to be adjacent to the plurality of light emitting regions. An optical portion is configured to emit light generated by the light source through the plurality of light emitting regions. A controller is configured to independently determine what light is emitted through each of the plurality of light emitting regions independently.

### CROSS-REFERENCE TO RELATED APPLICATION

This application claims benefit of priority to Korean Patent Application No. 10-2016-0015766 filed on Feb. 11, 2016 in the Korean Intellectual Property Office, the disclosure of which is incorporated herein by reference in its entirety.

### BACKGROUND

1. Field

The present inventive concept relates to a light emitting device and an electronic device including the same.

2. Description of Related Art

Semiconductor light emitting elements include elements, such as a light emitting diode (LED), or the like, and have many advantages, such as low power consumption, a high degree of brightness, a relatively long lifespan, and the like, and have been widely used as light sources. Semiconductor light emitting elements have been applied to devices within various fields as light sources. In addition, recently, research into various application to which semiconductor light emitting elements may be applied, besides that of general light emitting devices, such as backlight units, lighting apparatuses, or the like, is being conducted.

An aspect of the present inventive concept may provide a light emitting device disposed in a region of a cover panel mounted on a front surface of an electronic device, thereby implementing a flash function when a front camera unit is used, a notification function included in various applications, and the like.

According to an aspect of the present inventive concept, a light emitting device may include a cover panel including a plurality of light emitting regions, a plurality of light sources disposed on a surface of the cover panel to be adjacent to the plurality of light emitting regions, an optical portion configured to emit light generated by the plurality of light sources through the plurality of light emitting regions, and a controller configured to determine light emitted through each of the plurality of light emitting regions independently, by adjusting operations of the light source and the optical portion are controlled.

According to an aspect of the present inventive concept, an electronic device may include a cover panel including a plurality of light emitting regions, a light source mounted on a first surface of the cover panel and configured to generate light emitted through the plurality of light emitting regions; an optical portion disposed on the plurality of light emitting regions to be adjacent to the light source on the first surface of the cover panel, and a processor configured to control operations of the light source and the optical portion and execute a plurality of applications. In addition, the processor may detect an event occurring in respective applications among the plurality of applications, and may control at least one of the light source and the optical portion to allow light having different characteristics to be emitted through the plurality of light emitting regions based on the event.

An electronic device in accordance with principles of inventive concepts includes a cover panel including a plurality of openings for a light source and an opening for a display device; a light source mounted on a first surface of the cover panel and configured to generate light emitted through the plurality of openings; an optical portion disposed on the plurality of light emitting regions to be adjacent to the light source on the first surface of the cover panel; a display device mounted to provide a display though the display opening in the cover panel, wherein the optical portion is configured to prevent light generated by the light source from interfering with the display device; and a processor configured to control operations of the light source and the optical portion to generate light signals through the light source openings in the cover panel.

### BRIEF DESCRIPTION OF DRAWINGS

The above and other aspects, features and other advantages of the present inventive concept will be more clearly understood from the following detailed description taken in conjunction with the accompanying drawings, in which:

FIGS. 1A and 1B are exterior views of an electronic device including a light emitting device according to example embodiments of the present inventive concept;

FIG. 2 is an exploded perspective view of an electronic device according to an example embodiment of the present inventive concept;

FIGS. 3A and 3B are views of a light emitting element package employable in a light source of a light emitting device according to example embodiments of the present inventive concept;

FIG. 4 is a block diagram of a light emitting device according to an example embodiment of the present inventive concept;

FIGS. 5 to 13 are views illustrating operations of a light emitting device according to example embodiments of the present inventive concept;

FIGS. 14 to 18 are views of a backlight unit employable as a light emitting device according to example embodiments of the present inventive concept.

### DETAILED DESCRIPTION

Reference will now be made in detail to the embodiments of the present general inventive concepts, examples of which are illustrated in the accompanying drawings, wherein like reference numerals refer to the like elements throughout. The embodiments are described below in order to explain the present general inventive concepts by referring to the figures.

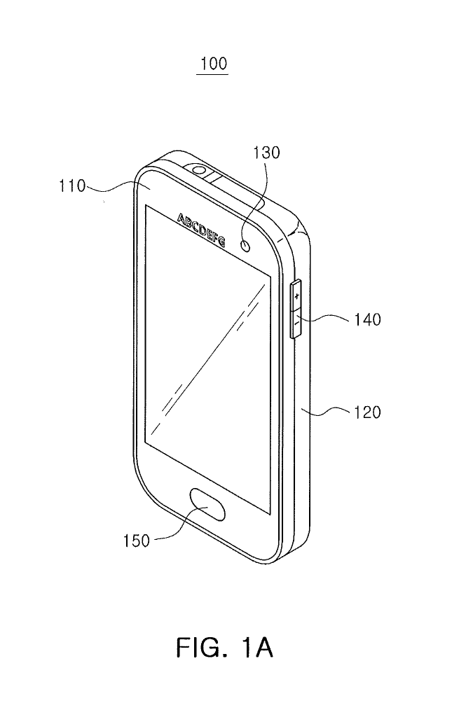

FIGS. 1A and 1B are exterior views of an electronic device including a light emitting device according to example embodiments of the present inventive concept.

With reference to FIG. 1A, an electronic device 100 according to an example embodiment of the present inventive concept may include a cover panel 110 mounted on a front of the electronic device 100, a housing 120 forming an exterior of the electronic device 100, a camera unit 130, a key input unit 140, a bio-signal sensor 150, and the like. The bio-signal sensor 150 may include a fingerprint sensor, or the like. Electronic device 100 may include, a display device, a touchscreen device, a memory, an audio input-output unit, a communications unit, a processor to control operations of the components, and the like. In FIGS. 1A and 1B, the electronic device 100 is illustrated as having a form of a smartphone, but is not limited thereto. In addition, for example, the electronic device 100 may be a tablet PC, a laptop computer, a personal digital assistant (PDA), a wearable information technology (IT) device, or the like.

The cover panel 110 may be mounted on the front of the electronic device 100 in which the display device outputs an image. The cover panel 110 may include a material having a high level of light transmittance, such as tempered glass, acryl, or the like. At least a portion of a region of the cover panel 110 may be a region on which an opaque material may be printed. Through the printing, a manufacturer logo of the electronic device 100, or the like, may be formed on the cover panel 110. Hereinafter, a description will be provided with reference to FIG. 1B.

FIG. 1B may be a view taken from the front of the electronic device 100. With reference to FIG. 1B, the cover panel 110 may include a first region 111, a second region 112, and a third region 113. The first region 111 may be a region in which the manufacturer logo of the electronic device 100, or the like, is formed, while the second region 112 may be a region in which the opaque material is printed on a rear surface of the cover panel 110. The third region 113 may be a region in which the image output by the display device is displayed. According to an example embodiment, the second region 112 may be defined as a region not including the first and third regions 111 and 113.

In other words, the opaque material may be printed on the rear surface of the cover panel 110, except in the first and third regions 111 and 113, so that the first, second, and third regions 111, 112, and 113 may be formed on the cover panel 110. As a result, different from the second region 112, light generated on the rear surface of the cover panel 110 may be emitted outwardly from the front surface of the electronic device 100 through the first and third regions 111 and 113. In a case in which the camera unit 130, the bio-signal sensor 150, or the like, operate on the front surface of the electronic device 100, a region corresponding to the camera unit 130, the bio-signal sensor 150, or the like, may be left un-printed with the opaque material in the same manner as the first and third regions 111 and 113, as illustrated in FIGS. 1A and 1B.

According to an example embodiment, the electronic device 100 may include a plurality of light emitting regions in the first region 111. The plurality of light emitting regions may be provided as the manufacturer logo of the electronic device 100, disposed in the first region 111, or the like. In FIGS. 1A and 1B, seven letters of the English alphabet, such as ‘[ABCDEFG]’, may be included in the first region 111. In example embodiments, the respective seven letters of the English alphabet may be provided as light emitting regions separated from each other.

According to an example embodiment of the present inventive concept, light having a specific level of brightness and a specific color is emitted through the plurality of light emitting regions, ‘[ABCDEFG]’, included in the first region 111, so that the first region 111 may perform functions as an indicator to offer a user information, or as a flash to support operations of the camera unit 130, or the like. To this end, on the rear surface of the cover panel 110, at least one or more light sources that may operate as a backlight unit may be disposed adjacently to the first region 111. In addition, in order to determine a region actually emitting light among the plurality of light emitting regions and to change a color of light emitted through the plurality of light emitting regions, an optical portion including a filter may be located on the first region 111 on the rear surface of the cover panel 110.

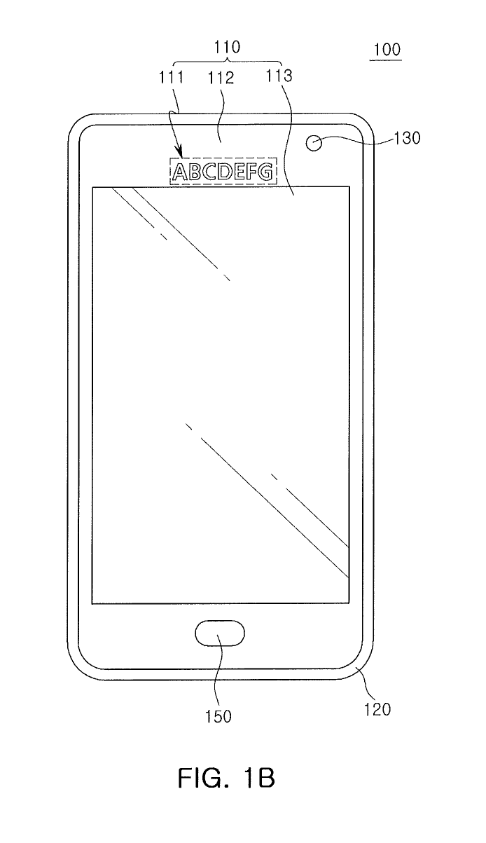

FIG. 2 is an exploded perspective view of an electronic device according to an example embodiment of the present inventive concept.

With reference to FIG. 2, a display device 160 may be disposed on the rear surface of the cover panel 110. The cover panel 110 may include the first, second, and third regions 111, 112, and 113 as described above. As described above, the second region 112 may be a region in which an opaque material is printed on the rear surface of the cover panel 110. The first region 111 may be a region in which the manufacturer logo of the electronic device 100, and the like, may be formed. Additionally, the third region 113 may be a region in which an image output by the display device 160 may be displayed.

According to an example embodiment, a light source 170 may be disposed adjacently to the first region 111 on the rear surface of the cover panel 110. The light source 170 may include an organic light emitting diode (OLED), a semiconductor light emitting element, or the like, for example. In embodiments in which the light source 170 may include the semiconductor light emitting element, the light source 170 may include a side-view type light emitting diode (LED) package emitting light in a lateral direction (in a direction of the first region 111), a chip scale package, or the like.

An optical portion 180 may be disposed on the first region 111 on the rear surface of the cover panel 110 so that light generated by the light source 170 may be emitted outwardly through a front surface of the electronic device 100 through the manufacturer logo, or the like, disposed in the first region 111. The optical portion 180 may prevent the light generated by the light source 170 from entering the display device 160, and the like, and may reflect the light to be emitted outwardly through the front surface of the electronic device 100. To this end, the optical portion 180 may include a light guide panel, a reflective plate, or the like.

In addition, the optical portion 180 may include a filter in order to adjust a color of the light emitted outwardly through the front surface of the electronic device 100 in the first region 111. The filter may have a composition similar to that of a color filter included in the display device 160. For example, each of the filters may be disposed to correspond to each letter of the manufacturer logo disposed in the first region 111. Each letter of the manufacturer logo disposed in the first region 111 may emit light having a different color by allowing each letter of the manufacturer logo to correspond to each (different) filter.

According to an example embodiment, the light source 170 and the optical portion 180 may be provided as a light emitting device 200 along with the cover panel 110 including the first region 111. Operations of the light emitting device 200 may be controlled by a controller. In addition, the controller may be provided as an integrated circuit chip provided separately or an application processor of the electronic device 100. The controller may emit various patterns of light through the first region 111 in such a manner that turning the respective light sources 170 on and off is controlled independently, and operations of the respective filters corresponding to the letters of the manufacturer logo are independently adjusted. Therefore, an event occurring in an application executed by the electronic device 100, a state of charge and discharge of a battery, and the like, may be displayed for a user through different patterns of light emitting operations, for example. In addition, when a camera unit 130 disposed on the front surface of the electronic device 100 operates, light emitted through the first region 111 may act as a flash.

The light emitting device 200 may be operated based on an initial configuration when the electronic device 100 is released, or based on a configuration set by the user at a later time. In other words, the user may set the operation of the light emitting device 200 by using the electronic device 100, thus simply identifying different events occurring in various applications.

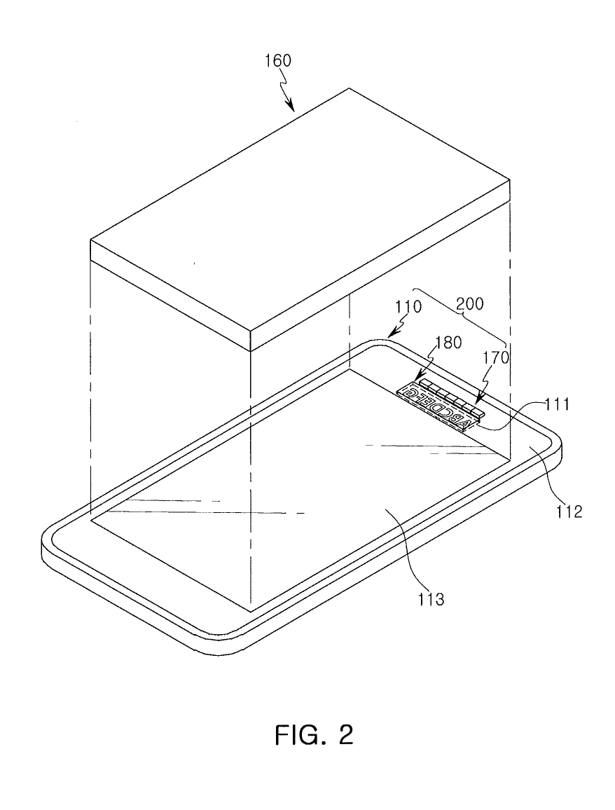

FIGS. 3A and 3B are views of a light emitting element package employable in a light source of a light emitting device according to example embodiments of the present inventive concept.

With reference to FIGS. 3A and 3B, a light emitting element package 170 according to example embodiments may be a side-view type LED package emitting light in a lateral direction. The light emitting element package 170 may include a package body 171, lead frames 174 and 175, a light emitting element 176 disposed in a mounting space 171a of the package body 171, and the like.

The package body 171 may include first and second bodies 172 and 173. The lead frames 174 and 175 may be disposed between the first and second bodies 172 and 173 or within the second body 173. The lead frames 174 and 175 may include first and second lead frames 174 and 175 electrically connected to first and second conductive semiconductor layers of the light emitting element 176, respectively. Portions of regions of the respective first and second lead frames 174 and 175 may be exposed outwardly to receive power.

The light emitting element 176 may be mounted on the first and second lead frames 174 and 175 in the mounting space 171a through a solder bump 177, or the like. In order to improve light output of the light emitting element package 170, a reflective layer having a high degree of light reflectivity may be disposed on an interior side of the first body 172 providing the mounting space 171a. In the light emitting device according to an example embodiment, besides the light emitting element package 170 illustrated in FIGS. 3A and 3B, various light emitting elements, such as a different type of a light emitting element package, an OLED, or the like, may be employed as a light source.

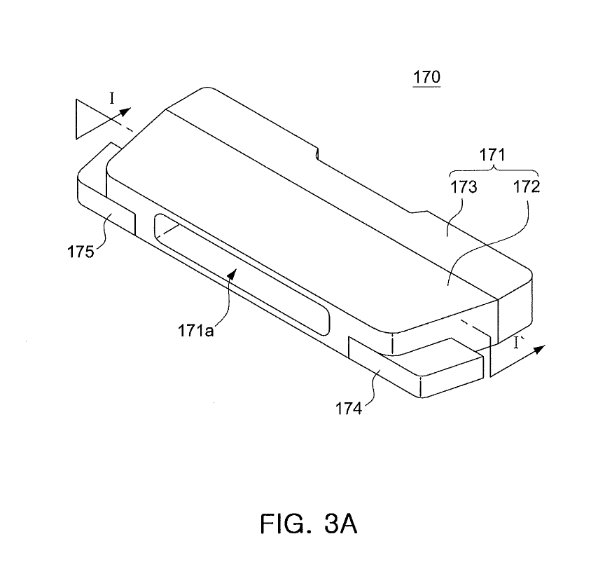

FIG. 4 is a block diagram of a light emitting device according to an example embodiment of the present inventive concept.

With reference to FIG. 4, a light emitting device 300 according to an example embodiment may include a cover panel 310 including first and second regions 311 and 312, a plurality of light sources 320, an optical portion 330, and a control unit 340. The cover panel 310 may include tempered glass, acryl, or the like, disposed on a front surface of an electronic device 100. The cover panel 310 may include the second region 312 formed in such a manner that an opaque material is printed and the first region 311, a region not including the second region 312. That is, an opaque material may be printed in the second region 312, but the remaining region, first region 311, may be left un-printed by the opaque material. The first region 311 may include a plurality of light emitting regions through which light may pass. In addition, the plurality of light emitting regions may correspond to a letter included in a manufacturer logo of the electronic device 100.

In a region adjacent to the first region 311, may reside the plurality of light sources 320 (e.g., light sources 321 to 327). The plurality of light sources 320 may emit light toward the first region 311, and may include a light emitting element package such as an LED or an OLED, or the like. With reference to FIG. 4, the plurality of light emitting regions included in the first region 311 may correspond to the plurality of light sources 320, respectively. Alternatively, two or more light emitting regions may correspond to a light source 320, or two or more light sources 320 may correspond to a light emitting region.

Each of the plurality of light sources 320 may emit light having the same color as or different color from the others. In an embodiment in which the plurality of light sources 320 respectively emit light having the same color, each of the plurality of light sources 320 may emit white light. Each of the plurality of light sources 320 may be driven by the control unit 340. The control unit 340 may independently adjust each of the plurality of light sources 320 being turned on or off, thus separately controlling whether or not each of the plurality of light emitting regions included in the first region 311 may emit light.

The optical portions 330 (e.g., optical portions 331 to 336) may include a reflective plate, a light guide panel, a filter, and the like, disposed below a letter included in the first region 311, for example. The reflective plate may reflect light emitted by the light source 320 to pass through the light emitting region in the first region 311, and may prevent the light emitted by the light source 320 from entering a component, such as a display device, and the like in an undesired manner. In the meantime, the filter may be disposed below the light emitting region included in the first region 311, thus separately controlling a color of light emitted through the respective light emitting regions. In an example embodiment such as that illustrated in FIG. 4, seven letters, namely, A, B, C, D, E, F, and G may emit light having different colors under control of a controller 341.

According to an example embodiment, the controller 341 may independently control light emitted through each letter included in the first region 341. For example, the controller 341 may control the letters A, B, C, D, E, F, and G so that among the letters included in the first region 311, a portion thereof may emit light, while the remainder thereof may not emit light. Alternatively, the controller 341 may control operations of the respective optical portions 330 disposed below the letter included in the first region 311, thus separately controlling whether or not light may be emitted through the letters included in the first region 311.

Controller 341 may also control the light emitted from each letter to have different colors. For example, in a case in which the light is only emitted through four letters, for example, A, C, D, and F, A and F may emit blue light while C and D may emit red light, or light having a different combination of colors may be emitted. Because a combination of light emitted through the first region 311 may be variously changed, the first region 311 may be used as an indicator representing a state of the electronic device 100. Hereinafter, operations of the light emitting device 300 according to an example embodiment will be described in detail.

In an example embodiment, the light emitting device 300 may include an OLED as the light source 320. Each of the plurality of light sources 320 corresponding to a plurality of letters included in the first region 311 may include an OLED capable of emitting red, green, and blue light. For example, the first light source 321 corresponding to letter A may include three OLEDs one emitting red, one emitting green, and one emitting blue light. Seventh light source 327 corresponding to letter G may also include three OLEDs emitting red, green, and blue light. In such an example embodiment, the optical portion 330 may include only the light guide panel, the reflective plate, and the like, without a color filter. Between the optical portions 330, a light shielding portion may be disposed in order to prevent the entry of light from optical portions 330 disposed adjacently thereto.

The controller 341 may control turning each of the OLEDs included in the light source 320 corresponding to each letter on and off, through a driving circuit 342, thereby independently controlling the ability of each letter included in the first region 311 to emit light and controlling the color of light emitted through each letter. In an example embodiment, the controller 341 may undertake controlling to allow the OLED included in the first, second, third, and fourth light sources 321, 322, 323, and 324 disposed adjacently to the letters A, B, C, and D to be driven and the OLED included in the fifth, sixth, and seventh light sources 325, 326, and 327 disposed adjacently to the letters E, F, and G not to be driven, so that light may be emitted through only the letters A, B, C, and D.

Controller 341 may separately control operations of red, green, and blue OLEDs included in each of the first, second, third, and fourth light sources 321, 322, 323, and 324, disposed adjacently to the letters A, B, C, and D, so that light having different colors may be emitted through the letters A, B, C, and D. For example, the first light source 321 may only drive the red OLED, the second light source 322 may only drive the green OLED, the third light source 323 may only drive the blue OLED, and the fourth light source 324 may drive an entirety of the red, green, and blue OLEDs, so that the letters A, B, C, and D may be controlled to emit red, green, blue, and white light, respectively.

Light emitting device 300 according to an example embodiment may include a semiconductor light emitting element as a light source. In such embodiments, the semiconductor light emitting element employed as the light source may be the same side-view type light emitting diode (LED) package as illustrated in FIGS. 3A and 3B. In embodiments in which a semiconductor light emitting element is employed as the light source, different from FIG. 4, the light sources 320 may not correspond to the plurality of letters included in the first region 311, respectively and a semiconductor light emitting element may be applied to two or more letters as the light source.

In embodiments in which a semiconductor light emitting element is used as the light source, the light emitting device 300 may have a composition similar to that of a liquid crystal display (LCD). The optical portion 330 may include the reflective plate and the light guide panel, reflecting light emitted by the semiconductor light emitting element to a front surface of a cover panel 110. Optical portion 330 may also include a transparent substrate having a color filter and a switching element to determine whether or not light may pass through the color filter. In such embodiments, below the first region 311 of the cover panel 310, the color filter, the transparent substrate including the switching element, the light guide panel, the reflective plate, and the like, may be disposed to provide the optical portion 330.

The ability of light to be transmitted through each of the plurality of letters included in the first region 311 and a color of the emitted light may be determined by the operation of the optical portion 330. For example, the controller 341 may control operations of the switching element included in the optical portion 330 to determine the ability of the letter included in the first region 311 to emit light and the color of the light. As a result, the color of the light emitted through each of the plurality of letters may be determined by light passing through red, green, and blue color filters disposed below each of the plurality of letters.

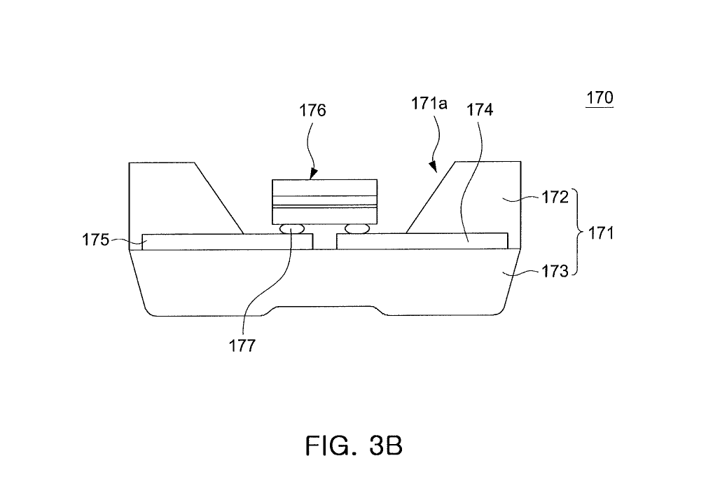

FIGS. 5 to 13 are views illustrating operations of a light emitting device according to example embodiments of the present inventive concept. Hereinafter, according to example embodiments illustrated in FIGS. 5 to 13, an electronic device 100 may include a light emitting device 200, including a light source 170 and an optical portion 180, disposed on a rear surface of a cover panel 110. In example embodiments illustrated in FIGS. 5 to 13, the light emitting device 200 may be based on the light emitting device illustrated in FIG. 2. However, the light emitting device 200 may be substituted with the light emitting device 300 according to an example embodiment illustrated in FIG. 4 or a light emitting device according to various other embodiments of the present inventive concept.

With reference to FIG. 5, the light emitting device 200 according to an example embodiment may act as a flash for capturing an image using a front camera unit 130. In order to output a sufficient amount of light to act as a flash, the light emitting device 200 may emit light through a plurality, an entirety, for example, of light emitting regions included in a first region 111 of the cover panel 110. In example embodiments the light emitting device 200 may emit light through an entirety of letters disposed in the first region 111 of the cover panel 110. Characteristics of light emitted through the first region 111 may be determined by operations of the light source 170 and the optical portion 180.

In an example embodiment in which light source 170 may include an LED package generating white light or an OLED, the light emitting device 200 may emit white light through the first region 111, thus implementing a function similar to a general flash. In another example embodiment, the light emitting device 200 may control the operation of the optical portion 180 based on a user's choice or an amount of ambient light so that a portion of the letters included in the first region 111 may not emit light. That is, when the light emitting device 200 acts as a flash for the front camera unit 130, the amount of light may be changed by adjusting the number of the letters actually emitting light and it may be changed according to the amount of ambient light and/or user preference.

In addition, the light emitting device 200 may provide an image filtering function, a white balance calibration function, or the like, when an image is captured using the front camera unit 130. The light emitting device 200 may change the color of the light emitted through each letter in the first region 111 using the filter included in the optical portion 180. Using the camera unit 130, the user may change the color of light emitted by the light emitting device 200, in an application through which an image is captured. The light emitting device 200 may provide the image filtering function or the white balance calibration function based on a user's settings, for example.

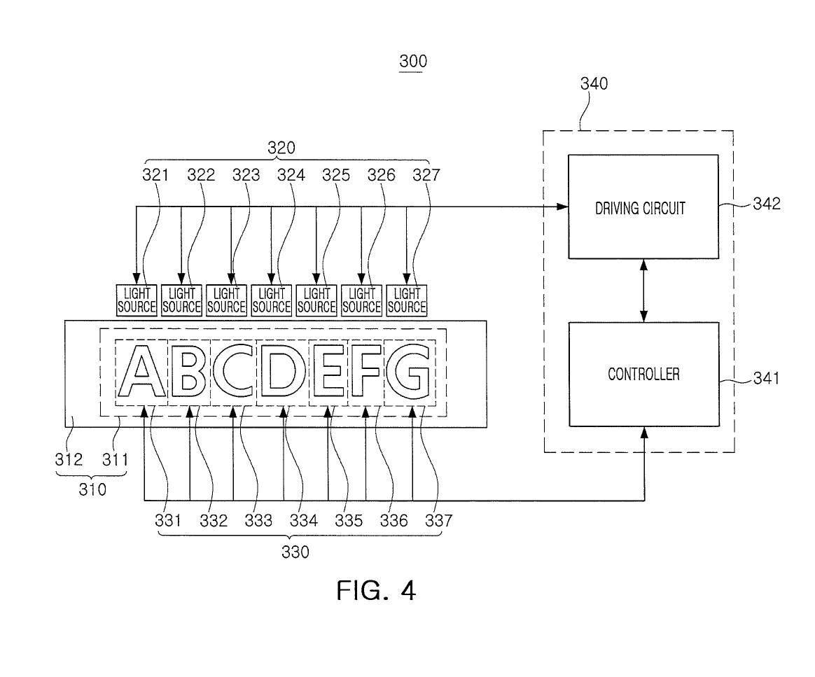

FIGS. 6 to 8 are views of a battery status display function of an electronic device 100 that may be provided using a light emitting device 200 according to example embodiments. The light emitting device 200 may display a state of charge and discharge of a battery as illustrated in FIGS. 6 to 8, when the electronic device 100 is connected to a wired or wireless charging device. While the electronic device 100 is operating in a sleep mode, the light emitting device 200 may regularly display the battery status, as illustrated in FIGS. 6 to 8.

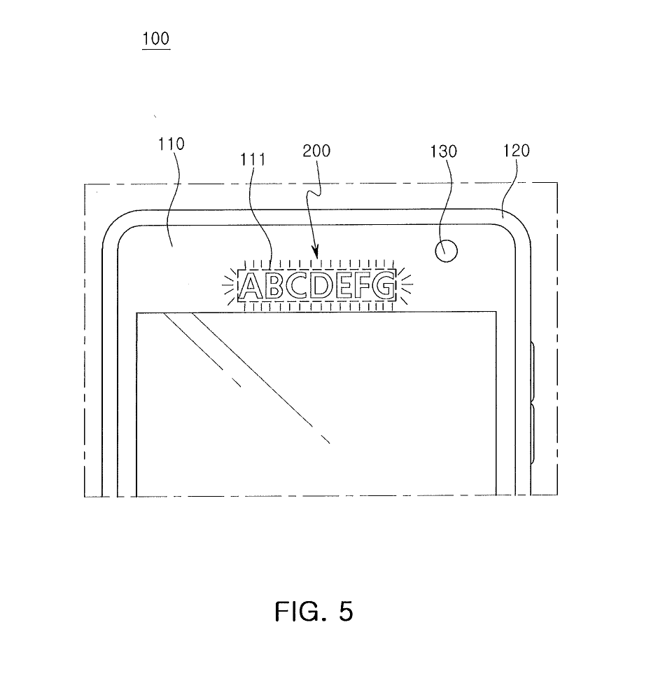

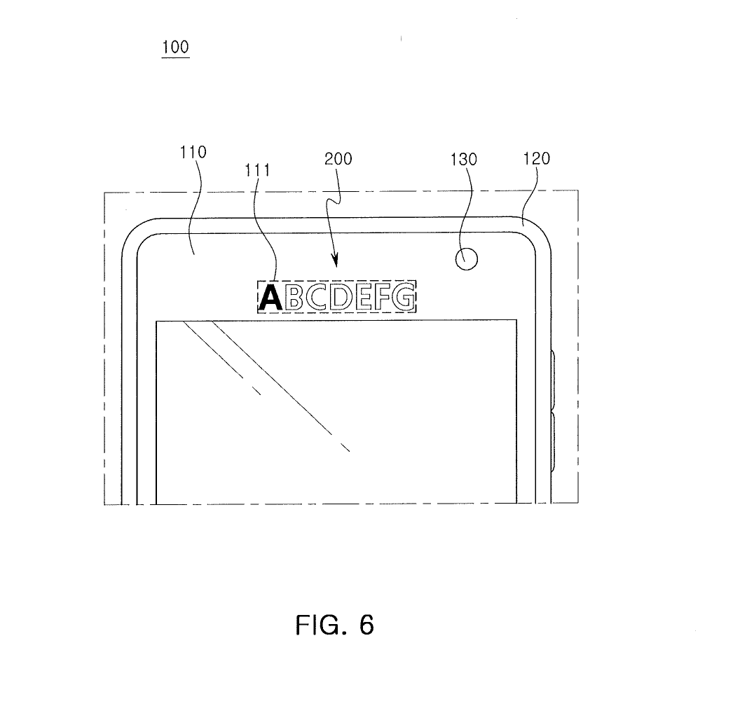

With reference to FIGS. 6 to 8, the battery status of the electronic device 100 may be displayed in such a manner that the number of letters emitting light in a first region 111 based on residual battery charge of the electronic device 100. In a situation in which the battery is almost depleted of charge, light may be emitted through only one letter disposed at the leftmost end, as illustrated in FIG. 6. In a situation in which the battery almost has a full charge, light may be emitted through an entirety of letters, as illustrated in FIG. 8. In a situation in which the residual battery charge is around half the full charge, light may be emitted, as illustrated in FIG. 7, with around half the letters lit. In other words, in an example embodiment, the light emitting device 200 may display the state of a battery in such a manner that the number or area of light emitting regions emitting light in the first region 111 may be changed to provide an analog of the state of charge, with half the regions emitting light for a half-charged state, all the regions emitting light of a fully-charged state, etc.

A light emitting operation of the first region 111 based on the residual battery charge may be determined by a light source 170 and an optical portion 180, disposed below the first region 111. As described with reference to FIG. 2 or 4, in a situation in which each of the plurality of letters disposed in the first region 111 corresponds to a light source 170, whether or not each letter may emit light may be determined, as example embodiments illustrated in FIGS. 6 to 8. However, in an embodiment in which a letter corresponds to a plurality of light sources 170 or the plurality of letters correspond to a light source 170, there may be a light emitting region and a non-light emitting region together within a letter.

In example embodiments illustrated in FIGS. 6 to 8, a color and operations of light emitted through the letter in the first region 111 may be variously changed. In an example embodiment, in a state in which the battery is almost depleted of charge as illustrated in FIG. 6, red light may be emitted. In a state in which the battery charge is high, as illustrated in FIG. 8, green light may be emitted. In addition, when the battery is charging, blue light may be emitted or light emitted through the first region 111 may flicker on a regular cycle, thus informing a user that the battery is now charging normally. That is, in example embodiments, the color of light emitted may be used as an indicator of battery status.

As an alternative to, or in combination with, example embodiments illustrated in FIGS. 6 to 8, the color of light, rather than a light emitting area, may be adjusted in the first region 111, thus displaying the battery status. The light emitting device 200 may emit light through the entirety of letters in the first region 111 regardless of residual battery charge, and may change the color of light depending on the battery status, thus displaying the battery status. For example, when the battery is low, the light emitting device 200 may emit red light through the first region 111, when the battery has a full charge, green light may be emitted through the first region 111, and when charging blue light may be emitted, thus informing the user of the battery status.

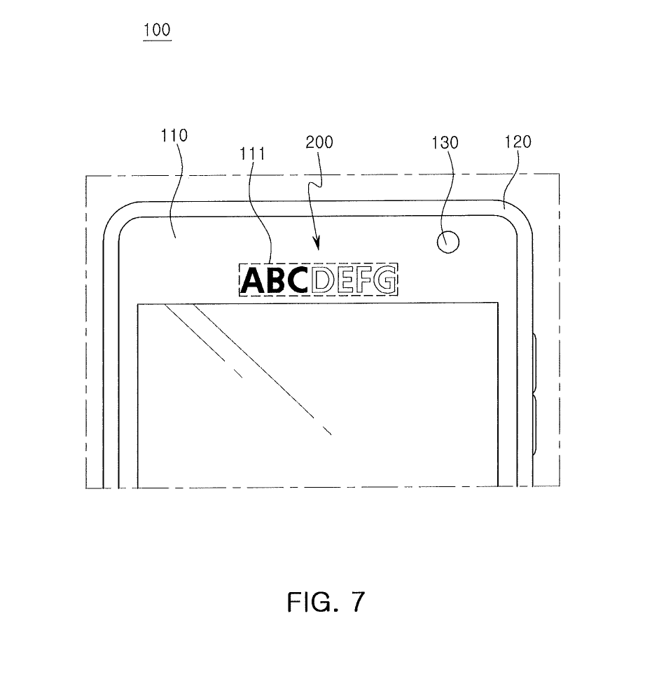

FIGS. 9 to 13 are views illustrating a notification function that may display an event occurring in an application run in an electronic device 100. In example embodiments illustrated in FIGS. 9 to 13, a combination of letters emitting light through a first region 111 and a color of light may be determined by a user's setting.

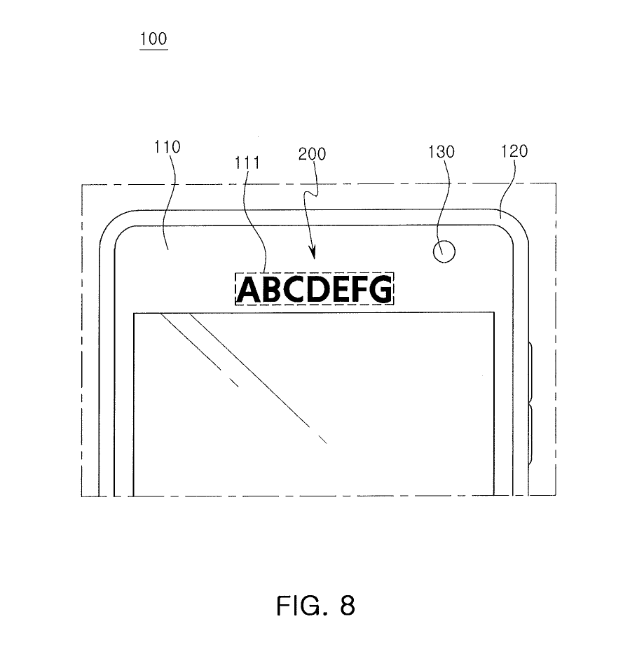

With reference to FIG. 9, a light emitting device 200 according to an example embodiment may emit light having a single color through a portion of a letter disposed in the first region 111, thus displaying an event occurring in an application executed by the electronic device 100. In an example embodiment illustrated in FIG. 9, a light emitting device may emit light having the same color, such as green light, through letters A, C, E, and G. In a case in which a different event occurs in the same application, or an event occurs in a different application, the color of light may be changed, or a letter emitting light may be changed, thus informing the user that a different event has occurred, as illustrated in FIGS. 10 to 13.

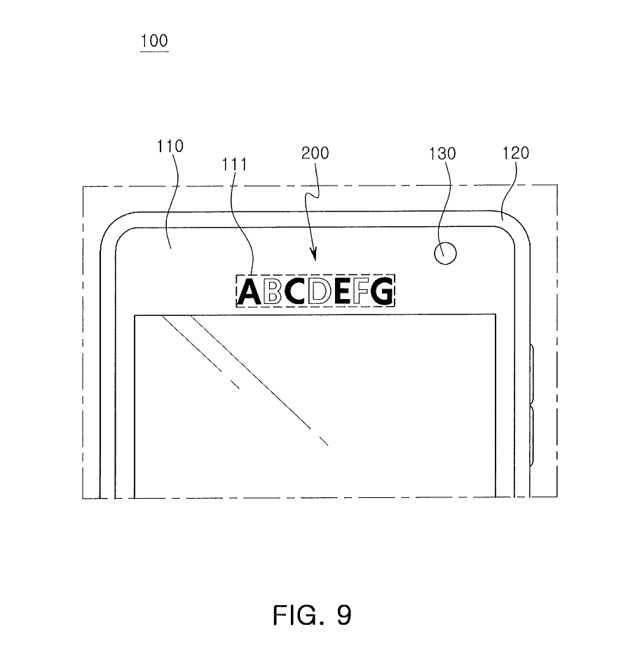

In comparison with example embodiments illustrated in FIGS. 10 and 11, a combination of letters emitting light may be changed, even though the light has the same color, thus displaying to the user that a different event has occurred. In an example embodiment illustrated in FIG. 10, light may be emitted through letters A, C, E, and G, while in an example embodiment illustrated in FIG. 11, light may be emitted through letters B, D, and F. In other words, the user may recognize which event has occurred in which application, based on the combination of letters emitting light, although light has the same color.

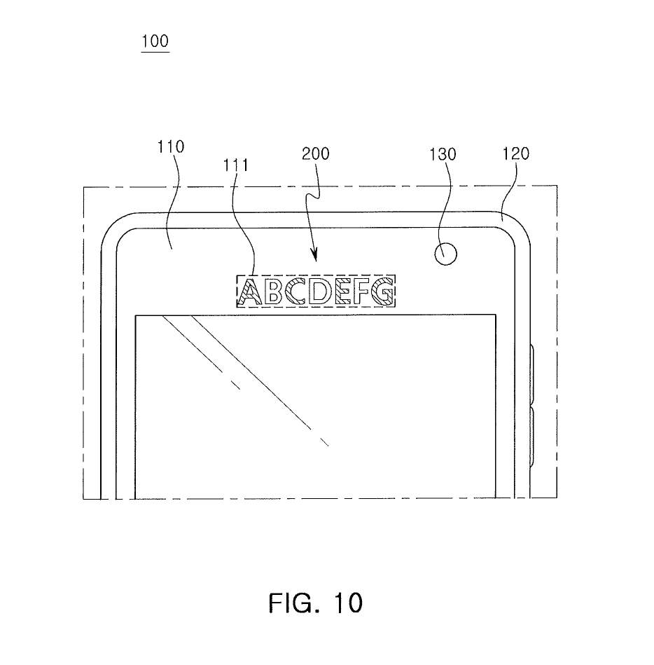

With reference to FIG. 12, light may be emitted through a letter different from that in FIGS. 9 to 11, and light having a color different from that in FIGS. 9 to 11 may be emitted, through a light emitting device 200. As a result, in a situation in which light is emitted as illustrated in FIG. 12, the user may recognize that an event different from that in FIGS. 9 to 11 has occurred in an application in the electronic device 100. As a result, based on the combination of letters emitting light and various colors of emitted light, the notification function through which a plurality of events occurring in a plurality of applications may be separately identified may be implemented.

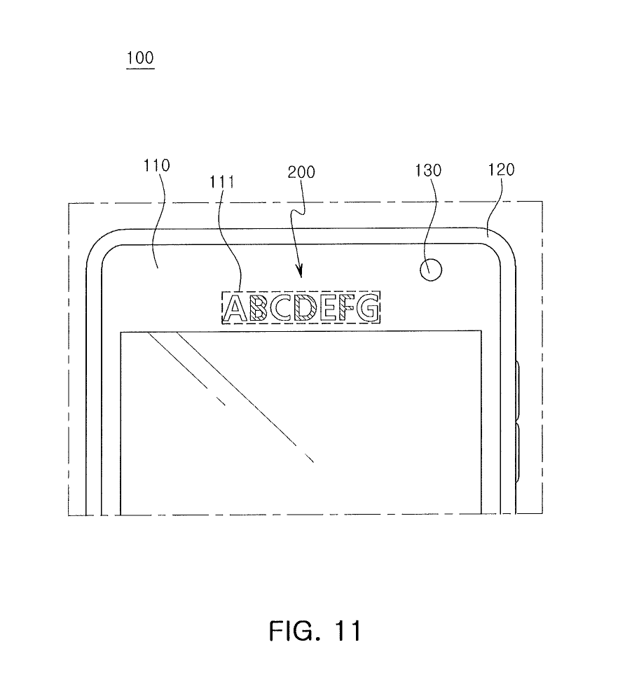

With reference to FIG. 13, a light emitting device 200 may emit light having different colors through a plurality of letters. As described with reference to FIG. 2, the light emitting device 200 may include a plurality of light sources 170 corresponding to the plurality of letters disposed in a first region 111 and an optical portion 180. The plurality of light sources 170 may correspond to the plurality of letters disposed in the first region 111, respectively. The optical portion 180 may include a plurality of filters corresponding to the plurality of letters, respectively and the light emitting device 200 may independently adjust a color of light emitted through each of the plurality of letters in such a manner that turning the plurality of light sources 170 on and off and operation of the plurality of filters may be separately controlled.

In an example embodiment illustrated in FIG. 13, light may be emitted through letters A, C, F, and G. That is, the light emitting device 200 may allow the light source 170 disposed adjacently to the letters A, C, F, and G to be turned on and the light emitting device 200 may control an optical portion disposed adjacent to letters B, D, and E so that light may not be emitted through the letters B, D, and E.

Light emitting device 200 may control operation of the optical portion 180 to allow light having different colors to be emitted through the letters A, C, F, and G. The light emitting device 200 may control to allow each letter to emit light having different colors, using the filter included in the optical portion 180. In the same manner as example embodiments illustrated in FIGS. 9 to 12, various types of notification may be implemented in such a manner that a combination of letters emitting light may be determined and the color of light emitted through each letter may be differently selected, as well as the combination of colors of light emitted through the first region 111 and the combination of letters emitting light may be adjusted.

Light emitting device 200 according to an example embodiment may emit light having various patterns through a cover panel 110 disposed on a front surface of the electronic device 100. Different from the prior art including a point light source that may only change the color of light to provide a user notification, the electronic device 100 may intuitively and rapidly inform a user of an event occurring in various applications, battery status, and the like, through including the light emitting device according to an example embodiment of the present inventive concept.

In a case in which the electronic device 100 includes the point light source only allowing for a change of color and a blinking operation, because the electronic device 100 may only provide a notification through a color of the point light source and the blinking operation, the number of notifications able to be provided to a user may be significantly limited. In such case, the user may have difficulty in fully grasping the type of notification through only the point light source mounted on the front surface of the electronic device 100 and, in example embodiments, a user may determine the type of notification through turning off the sleep mode in the electronic device 100.

In an example embodiment, the light emitting device 200 may emit light through various combinations of the plurality of letters disposed in the cover panel 110. To this end, the light emitting device 200 may include the light source 170 and the optical portion 180. That is, the light emitting device 200 may operate in a similar manner to an edge-type backlight unit. In addition, in the same manner as example embodiments illustrated in FIGS. 9 to 13, the ability to emit light through each of the plurality of letters disposed in the cover panel 110 and the color of the emitted light may be independently controlled. In addition, the user may be made more intuitively aware of the type of notification by allowing the user to set the color of light emitted depending on an event occurring in an application in the electronic device 100 and the combination of letters emitting light.

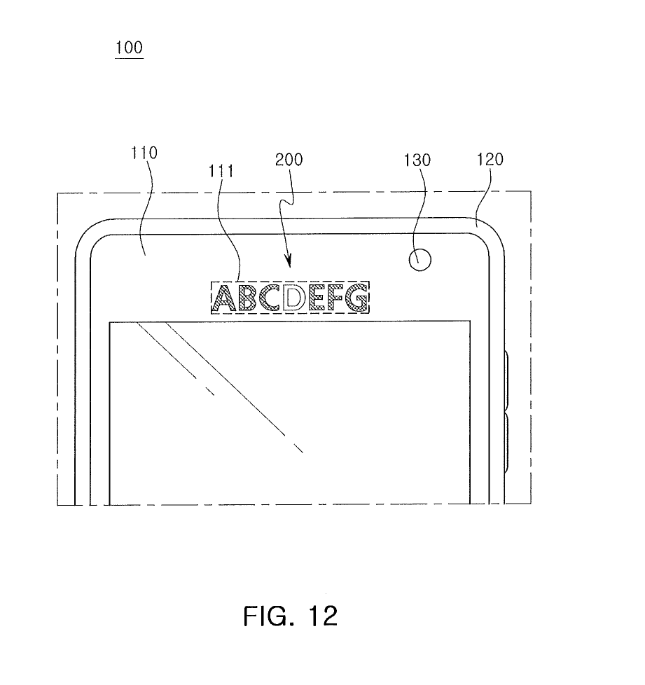

FIGS. 14 to 18 are views of a backlight unit employable as a light emitting device according to example embodiments of the present inventive concept.

With reference to FIG. 14, a backlight unit 1000 may include a light guide panel 1040 and a light source module 1010 disposed on opposing sides of the light guide panel 1040. Backlight unit 1000 may further include a reflective plate 1020 disposed below the light guide panel 1040. The backlight unit 1000 may be an edge-type backlight unit, for example.

Light source module 1010 may be provided on a side of the light guide panel 1040 or may be further provided on another side thereof. The light source module 1010 may include a printed circuit board 1001 and a plurality of light sources 1005 mounted on an upper surface of the printed circuit board 1001.

In a case in which the backlight unit 1000 illustrated in FIG. 14 is employed as a light emitting device according to an example embodiment, a cover panel 110 may be mounted above the light guide panel 1040. That is, in example embodiments light emitted by the light source module 1010 may be emitted through the cover panel 110 disposed above the light guide panel 1040 through the light guide panel 1040 and the reflective plate 1020. In such embodiments, between the cover panel 110 and the light guide panel 1040, a filter to change a color of light emitted through the cover panel 110 may be disposed. In addition, in order to selectively emit light through each of a plurality of letters disposed in the cover panel 110, the light guide panel 1040 may be split into a plurality of regions to provide a local dimming function.

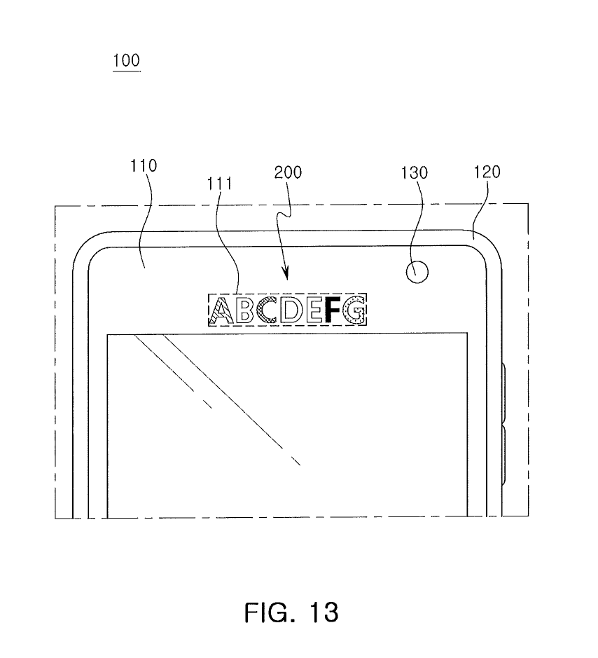

With reference to FIG. 15, a backlight unit 1100 may have a light source 1105 mounted on a circuit board 1101, and may include one or more optical sheets 1106 disposed above the light source 1105. The light source 1105 may be a light emitting device including a red phosphor according to an example embodiment of the present inventive concept.

The circuit board 1101 employed in an example embodiment may include a first planar portion 1101a corresponding to a main region, a slope portion 1101b disposed around the first planar portion 1101a to have a broken form in at least a joint thereof, and a second planar portion 1101c disposed in a corner of the circuit board 1101, an outside of the slope portion 1101b. The light sources 1105 may be disposed at a first interval d1 on the first planar portion 1101a, while one or more light sources 1105 may be disposed at a second interval d2 on the slope portion 1101b. The first interval d1 may be the same as the second interval d2. A width (or a length in a cross section) of the slope portion 1101b may be less than that of the first planar portion 1101a, and may be greater than that of the second planar portion 1101c. In addition, on the second planar portion 1101c, at least one light source 1105 may be disposed.

An angle of the slope portion 1101b may be adjusted within a range of being greater than 0° and less than 90° based on the first planar portion 1101a. The circuit board 1101 may have the structure to be able to maintain a uniform level of brightness adjacent to an edge of the optical sheet 1106.

In a case in which the backlight unit 1100 according to an example embodiment illustrated in FIG. 15 is employed in the light emitting device 200 according to an example embodiment, the filter and a cover panel 110 may be disposed above the optical sheet 1106. In such embodiments, in order to selectively emit light through each of a plurality of letters disposed in the cover panel 110, the optical sheet 1106 may be split into a plurality of regions to provide a local dimming function.

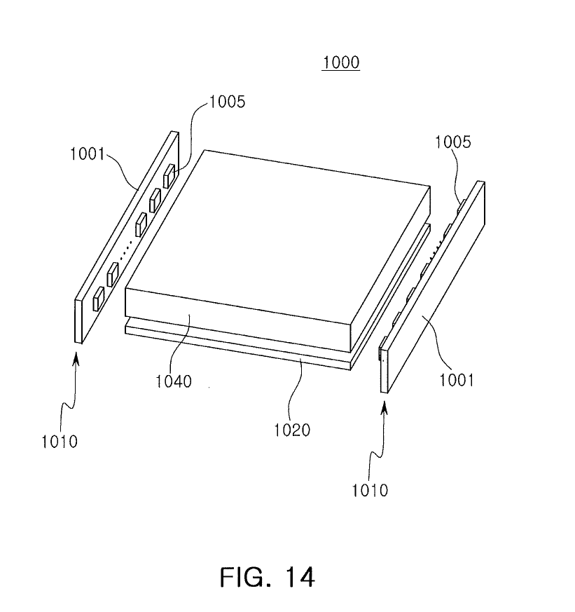

FIGS. 16 to 18 are schematic cross-sectional views of various backlight units employable in a light emitting device according to example embodiments of the present inventive concept.

In the case of a backlight unit 1200, 1300, or 1400, illustrated in FIGS. 16 to 18, a wavelength conversion portion 1250, 1350, or 1450 may not be disposed in an interior of a light source 1205, 1305, or 1405, but may be disposed on an exterior thereof in the backlight unit 1200, 1300, or 1400 to convert light presented to a user to a different color.

With reference to FIG. 16, the backlight unit 1200 may be a direct type backlight unit, and may include the wavelength conversion portion 1250, a light source module 1210 disposed below the wavelength conversion portion 1250, and a bottom case 1260 containing the light source module 1210. In addition, the light source module 1210 may include a printed circuit board 1201 and a plurality of light sources 1205 mounted on the printed circuit board 1201.

In the backlight unit 1200 in the example embodiment, the wavelength conversion portion 1250 may be disposed above the bottom case 1260. Accordingly, at least a portion of light emitted by the light source module 1210 may be wavelength-converted by the wavelength conversion portion 1250. The wavelength conversion portion 1250 may be manufactured as a separate film shape to be applied, but may be provided to have a type combined with a light diffusion plate not illustrated.

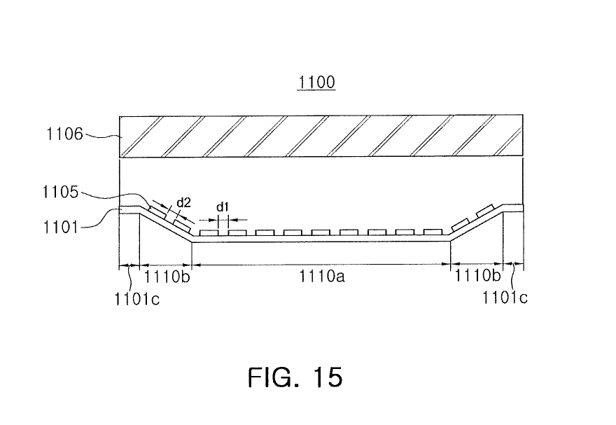

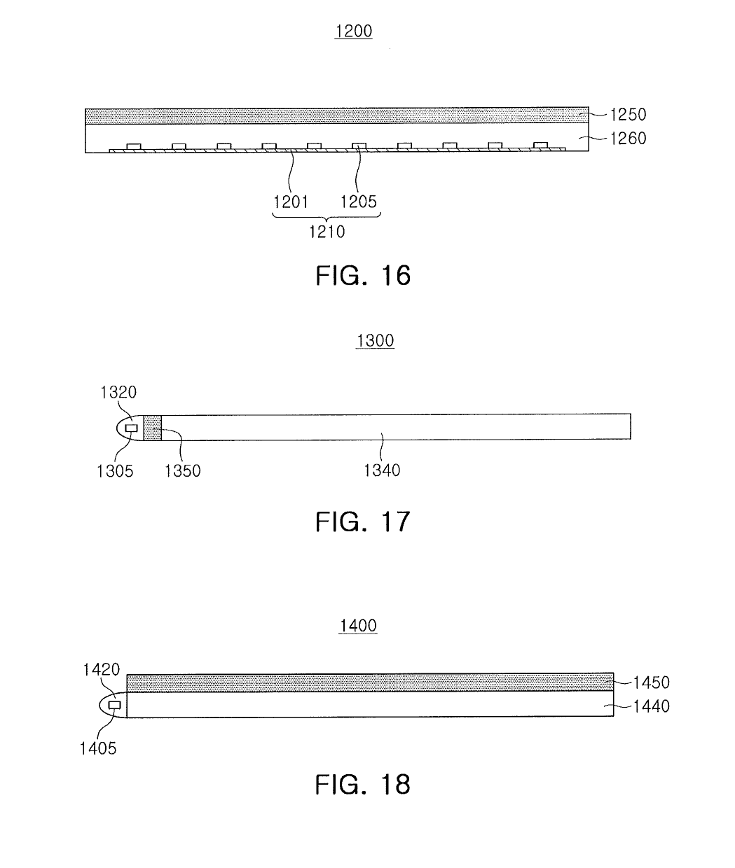

With reference to FIGS. 17 and 18, a backlight unit 1300 or 1400 may be an edge-type backlight unit, and may include a wavelength conversion portion 1350 or 1450, a light guide panel 1340 or 1440, a reflective portion 1320 or 1420, disposed on a side of the light guide panel 1340 or 1440, and a light source 1305 or 1405.

Light emitted by the light source 1305 or 1405 may be guided to an interior of the light guide panel 1340 or 1440 by the reflective portion 1320 or 1420. In the backlight unit 1300 illustrated in FIG. 17, the wavelength conversion portion 1350 may be disposed between the light guide panel 1340 and the light source 1305. In the backlight unit 1400 illustrated in FIG. 18, the wavelength conversion portion 1450 may be disposed on a light emitting surface of the light guide panel 1440.

In FIGS. 16 to 18, the wavelength conversion portion 1250, 1350, or 1450 may include a general phosphor. In detail, in a case in which a quantum dot phosphor is used to supplement characteristics of a quantum dot vulnerable to heat or moisture generated from a light source, a structure of the wavelength conversion portion 1250, 1350, or 1450, illustrated in FIGS. 16 to 18, may be used in the backlight unit 1200, 1300, or 1400.

In example embodiments illustrated in FIGS. 16 to 18, the wavelength conversion portion 1250, 1350, or 1450, provided in the backlight unit 1200, 1300, or 1400, may substitute a role of a filter included in the light emitting device 200 according to an example embodiment. In this case, a color of light emitted through a letter in a cover panel 110 may be determined by the light passing through the wavelength conversion portion 1250, 1350, or 1450. Alternatively, a separate filter may be disposed on the wavelength conversion portion 1250, 1350, or 1450 to change the color of light emitted through the letter in the cover panel 110 as needed.

As set forth above, according to example embodiments of the present inventive concept, a light emitting device may emit light through a plurality of light emitting regions disposed on a cover panel, and may independently control the ability of each of a plurality of light emitting regions to emit light, colors of emitted light, and the like. In accordance with principles of inventive concepts, a notification function for various applications, a flash function for a front camera unit, and the like, may be performed through a portion of a region on the cover panel of an electronic device.

While example embodiments have been shown and described above, it will be apparent to those skilled in the art that modifications and variations could be made without departing from the scope of the present inventive concept as defined by the appended claims.

What is claimed is:

1. A light emitting device, comprising:
a cover panel including a plurality of light emitting regions;
a plurality of light sources disposed on a surface of the cover panel adjacent to the plurality of light emitting regions;
an optical portion configured to emit light generated by the plurality of light sources through the plurality of light emitting regions; and
a controller configured to adjust a light source and optical portion to control light emitted through each of the plurality of light emitting regions independently.

2. The light emitting device of claim 1, wherein the light source comprises a plurality of light sources each corresponding to one of the plurality of light emitting regions.

3. The light emitting device of claim 2, wherein each of the plurality of light sources comprises a plurality of light emitting elements generating different colors.

4. The light emitting device of claim 3, wherein the controller independently determines a color of the light emitted through each of the plurality of light emitting regions by adjusting operations of the plurality of light emitting elements.

5. The light emitting device of claim 1, wherein each of the plurality of light sources comprises a light emitting element generating white light; and
the optical portion comprises a plurality of filters filtering the white light to transmit a selected color from the white light generated by the light emitting element.

6. The light emitting device of claim 5, wherein the controller independently determines a color of the light emitted through each of the plurality of light emitting regions by adjusting at least one of the plurality of filters.

7. The light emitting device of claim 1, wherein the plurality of light sources comprise at least one of a semiconductor light emitting element and an organic light emitting diode (OLED).

8. The light emitting device of claim 1, wherein the cover panel comprises a first region including the plurality of light emitting regions, a second region surrounding the first region, and a third region provided as an image display region.

9. The light emitting device of claim 1, wherein the controller is configured to be responsive to user input to determine the light emitted through each of the plurality of light emitting regions.

10. An electronic device, comprising:
a cover panel including a plurality of light emitting regions;
a light source mounted on a first surface of the cover panel and configured to generate light emitted through the plurality of light emitting regions;
an optical portion disposed on the plurality of light emitting regions to be adjacent to the light source on the first surface of the cover panel; and
a processor configured to control operations of the light source and the optical portion and to execute a plurality of applications,
wherein the processor is configured to detect an event occurring in respective applications among the plurality of applications, and controls at least one of the light source and the optical portion to allow light having characteristics associated with the event to be emitted through the plurality of light emitting regions.

11. The electronic device of claim 10, wherein the light source comprises a plurality of light emitting elements; and
the processor independently controls operations of each of the plurality of light sources based on the event.

12. The electronic device of claim 10, wherein the processor controls operations of at least one of the light source and the optical portion to allow different colors of light to be emitted through each of the plurality of light emitting regions based on the event.

13. The electronic device of claim 10, wherein the processor independently determines whether or not each of the plurality of light emitting regions emits light based on the event.

14. The electronic device of claim 10, wherein the processor is configured to receive and store configuration information of at least one among the plurality of applications, and to determine the light emitted through the plurality of light emitting regions based on the configuration information and the occurrence of the event.

15. The electronic device of claim 10, wherein the plurality of light sources comprise at least one of a semiconductor light emitting element and an OLED.

16. An electronic device, comprising:
a cover panel including a plurality of openings for a light source and an opening for a display device;
a light source mounted on a first surface of the cover panel and configured to generate light emitted through the plurality of openings;
an optical portion disposed on the plurality of openings for the light source to be adjacent to the light source on the first surface of the cover panel;
a display device mounted to provide a display though the display opening in the cover panel, wherein the optical portion is configured to prevent light generated by the light source from interfering with the display device; and
a processor configured to control operations of the light source and the optical portion to generate light signals through the light source openings in the cover panel.

17. The electronic device of claim 16, wherein the processor is configured to provide a display that is an analog for a battery-charge state of the electronic device using the light source.

18. The electronic device of claim 17, wherein the color of light emitted through light source openings in the cover panel is an analog for the battery-charge state of the electronic device.

19. The electronic device of claim 17, wherein the number of light source openings in the cover panel emitting light is an analog for the battery-charge state of the electronic device.

20. The electronic device of claim 17, wherein the device includes a camera and the light source and openings are employed to provide a flash for the camera.
